(19) United States
(12) Patent Application Publication
(10) Pub. No.: US 2007/0139403 A1
(43) Pub. Date: Jun. 21, 2007

(54) Visual Display Driver and Method of Operating Same

(75) Inventor: Kyu Young Chung, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/555,813

(22) Filed: Nov. 2, 2006

(30) Foreign Application Priority Data
Dec. 20, 2005 (KR) 2005-126279

(51) Int. Cl. G09G 5/00

(52) U.S. Cl. 345/204

(57) ABSTRACT

A visual display driver (e.g., LCD display driver) includes a memory array and a multiplexer unit therein. The memory array includes a plurality of rows and columns of memory cells and the multiplexer unit includes a plurality of N-to-1 multiplexers. These multiplexers are configured to route display data from N×M columns in the memory array to an M-bit wide display data bus, in response to a multiplexer control signal. An M-bit latch unit and a channel source driver are also provided. The latch unit is electrically coupled to an output of the multiplexer unit and the channel source driver is electrically coupled to an output of the M-bit latch unit. The driver also includes an address converter. This address converter is configured to convert multiple distinct line addresses applied thereto into a corresponding plurality of distinct memory addresses that map to a single row within the memory array.

### REFERENCE TO PRIORITY PATENT APPLICATION

This application claims the benefit of Korean Patent Application No. 10-2005-0126279, filed on Dec. 20, 2005, in the Korean Intellectual Property Office, the disclosure of which is hereby incorporated herein in its entirety by reference.

### FIELD OF THE INVENTION

The present invention relates to display devices and methods of operating same and, more particularly, to display devices that utilize integrated circuit memories to store frames of display data.

### BACKGROUND OF THE INVENTION

A liquid crystal display (LCD) is widely used as a display device for notebook computers, monitors, etc. The LCD has a panel for displaying images and the panel includes a plurality of pixels arranged in a two-dimensional array. The plurality of pixels are respectively formed at intersections of a plurality of scan lines transferring a gate select signal and a plurality of data lines transferring color data, which may take the form of gray-scale data.

A driving IC for driving a display device such as an LCD can be designed such that a scan driver for driving scan lines and a source driver for driving data lines are integrated on a single chip. A conventional driving IC for a display device will now be explained with reference to FIG. 1. Referring to FIG. 1, the conventional driving IC includes a memory 10 for storing gray-scale data and a source driver 20 that receives the gray-scale data from the memory 10, converts the received gray-scale data into analog signals and transmits the analog signals to a panel.

When a single frame is represented by gray-scale data corresponding to A columns×B lines on the display, the memory 10 includes memory cells corresponding to A columns×B lines (e.g., rows). To represent the gray-scale of one line of the frame to be displayed, gray-scale data of A columns is stored in one row of the memory 10. In FIG. 1, gray-scale data 1-1 through 1-A corresponding to one line of the frame is stored in the first row of the memory 10 and gray-scale data 2-1 through 2-A corresponding to another line of the frame is stored in the second row of the memory 10.

The gray-scale data stored in the memory 10 is read in parallel row by row and is transmitted to the source driver 20. Gray-scale data read from each of the columns in one row can be 1-bit gray-scale data or multi-bit gray-scale data. When the memory 10 is a graphic RAM, for example, the gray-scale data read from each column can be M-bit gray-scale data corresponding to each of the channels of the source driver 20. The source driver 20 converts the gray-scale data corresponding to each channel into analog signals and transmits the analog signals to the pixels (R, G or B) of the panel.

While the lateral layout pitch of the memory 10 is continuously decreased as the driving IC becomes more highly integrated, similar reductions in the pitch of the source driver 20 may not be possible. Thus, the pitch of the memory 10 and the pitch of the source driver 20 may be mismatched and therefore result in an increase in routing space between the memory 10 and the source driver 20.

### SUMMARY OF THE INVENTION

Embodiments of the present invention include display devices having display drivers therein. These display drivers include a memory array, which has a plurality of rows and columns of memory cells therein, and a multiplexer unit. The multiplexer unit includes a plurality of N-to-1 multiplexers configured to route display data from N×M columns (single bit or multi-bit columns) in the memory array to an M-bit (or an M-word) wide data bus, in response to a multi-bit multiplexer control signal. Both N and M may be positive integers greater than one. The display drivers may also include an M-bit (or M-word) latch unit, which is electrically coupled to an output of the multiplexer unit, and a channel source driver that is electrically coupled to an output of the M-bit latch unit. The use of a plurality of N-to-1 multiplexers enables a closer layout match to be achieved between a width of the memory array and a width of the channel source driver, which has a larger per bit layout area requirement relative to the memory cells within the memory array.

Display drivers according to additional embodiments of the invention include an address converter. This address converter is configured to convert multiple distinct display line addresses applied thereto into a corresponding plurality of distinct memory addresses that map to a single row within the memory array. In particular, the plurality of distinct memory addresses may map to different columns (single bit or multi-bit columns (e.g., column groupings)) within the single row. For example, a first one of the memory addresses may map to columns 0, N, 2N, . . . in a selected row, a second one of the memory addresses may map to columns 1, N+1, 2N+1, . . . in the selected row, and a third one of the memory addresses may map to columns 2, N+2, 2N+2, . . . in the selected row, etc.

Still further embodiments of the present invention include a visual display driver having a memory array and an address converter therein. This address converter is configured to convert multiple distinct line addresses (corresponding to lines in a display) applied thereto into a corresponding plurality of distinct memory addresses that map to a single row within the memory array. In particular, the address converter may be configured to convert N consecutively valued line addresses applied thereto into a corresponding plurality of distinct memory addresses that map to a single row in the memory array, where N is a positive integer greater than one. These embodiments may also include a multiplexer unit having a plurality of N-to-1 multiplexers therein. These multiplexers are configured to route display data from N×M columns in the memory array to an M-bit wide (or M-word wide) display data bus, in response to a multiplexer control signal, where M is a positive integer greater than one.

Still further embodiments of the invention include methods of operating a graphics display by reading a row of display data from a graphics memory array and then extracting multiple lines of frame data from the row of display data. These multiple lines of frame data are then sequentially scanned onto corresponding lines within the display. This extracting step may include passing N lines of frame data in sequence through an N-to-1 multiplexer unit, wherein N is a positive integer greater than one.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional driving IC for a display device;

FIG. 2 is a block diagram of a driving IC for a display device according to an embodiment of the present invention;

FIG. 3 is a block diagram of a section of the driving IC of FIG. 2;

FIG. 4a is an electrical schematic of a multiplexer unit of FIG. 2;

FIG. 4b is a timing diagram of control signals that illustrate operation of multiplexer unit of FIG. 4a;

FIGS. 5a and 5b are diagrams for illustrating operation of the address converter of FIG. 2;

FIG. 6 is a block diagram of a driving IC, according to embodiments of the present invention;

FIG. 7 is a timing diagram that illustrates operation of the driving IC of FIG. 6; and

FIG. 8 is a flow chart illustrating a display driving method according to an embodiment of the present invention.

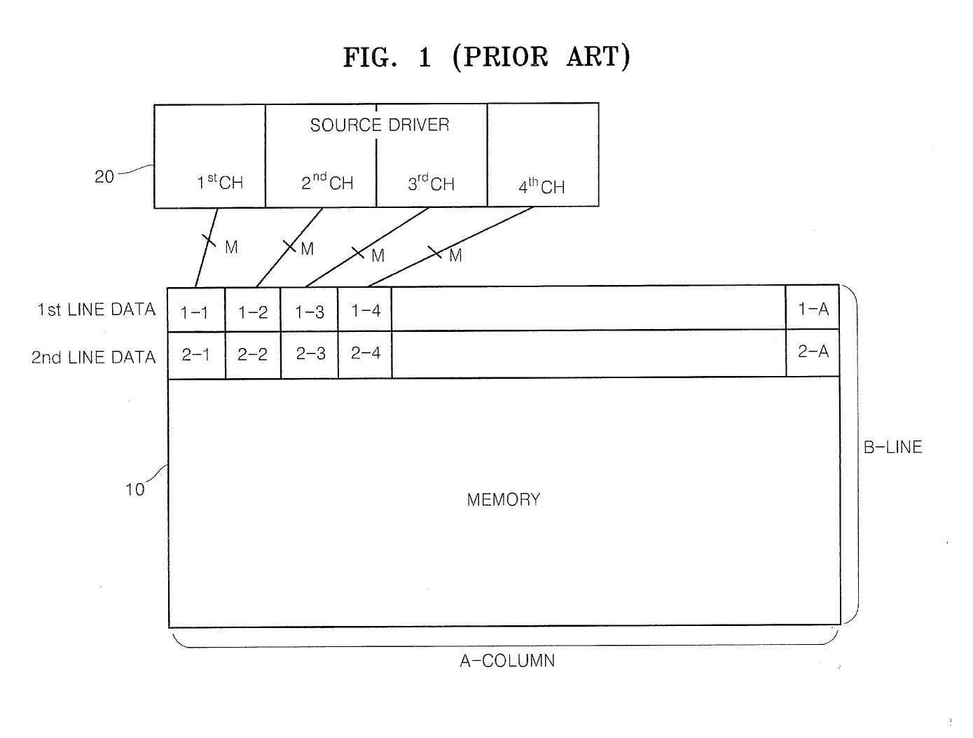

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Throughout the drawings, like reference numerals refer to like elements. In addition, the references “N” and “n” will be treated herein as equivalent integers.

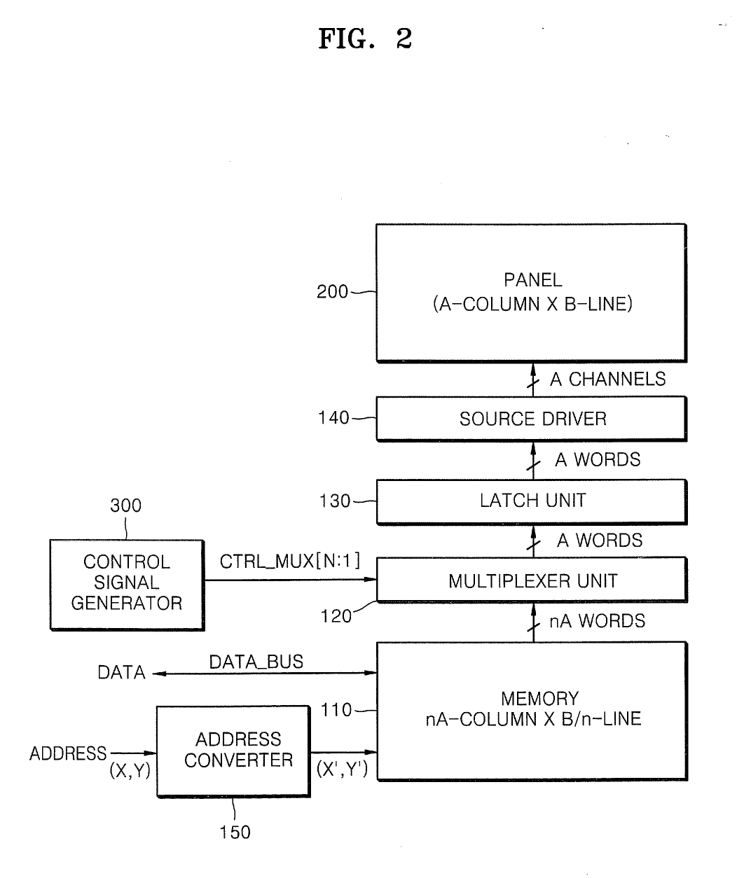

FIG. 2 is a block diagram of a driving IC for a display device according to an embodiment of the present invention. Referring to FIG. 2, the driving IC for a display device includes a memory 110, a multiplexer unit 120, a latch unit 130, which is optional, and a source driver 140. The driving IC may further include an address converter 150 for converting first address data into second address data. The driving IC may further include a control signal generator 300 for generating a control signal(s) for controlling the multiplexer unit 120.

The memory 110 stores gray-scale data corresponding to frames of an image to be displayed on a panel 200. Gray-scale data corresponding to A columns×B lines represents a single frame. The memory 110 includes memory cells corresponding to nA columns×B/n lines, which store the gray-scale data corresponding to A columns×B lines for a single frame, where “n” is a positive integer greater than one. That is, the memory 110 stores gray-scale data of nA columns in one line. Gray-scale data read from the columns of one line of the memory 110 can be 1-bit gray-scale data or multi-bit gray-scale data. When the memory 110 is a graphic RAM, gray-scale data in the unit of a word is read from each column. A single word can be composed of M-bit gray-scale data representing the gray-scale of a single pixel (R, G or B) of the panel 200. The gray-scale data of the nA columns, read from one line of the memory 110, is input to the multiplexer unit 120 in parallel. When the gray-scale data in the unit of a word is read from each column, gray-scale data of nA words is input to the multiplexer unit 120, as illustrated in FIG. 2.

The multiplexer unit 120 receives the gray-scale data of the nA columns and sequentially outputs the gray-scale data by A columns for representing the gray-scale of one line of the panel 200. That is, the gray-scale data of the nA columns, stored in one line of the memory 110, corresponds to gray-scale data of n lines of a single frame, and the multiplexer unit 120 sequentially outputs gray-scale data of the n lines line by line.

The multiplexer unit 120 may include a plurality of n-to-1 multiplexers. Each of the plurality of n-to-1 multiplexers receives gray-scale data of n columns and sequentially outputs the gray-scale data of the n columns column by column. The gray-scale data of the n columns input to each of the n-to-1 multiplexers corresponds to gray-scale data of n lines of one column of the frame,

The latch unit 130 is connected to an output terminal of the multiplexer unit 120, receives the gray-scale data sequentially output from the multiplexer unit 120 and latches the received gray-scale data. The source driver 140 receives the gray-scale data serially output from the latch unit 130, carries out an operation such as level-shifting and decoding on the received gray-scale data and sequentially outputs the gray-scale data to the panel 200. When a single frame is represented by the gray-scale data corresponding to A columns×B lines, the source driver 140 can include A channels each processing gray-scale data of one column and transferring the processed gray-scale data to each pixel (R, G or B) of the panel 200.

To map the gray-scale data corresponding to A columns×B lines for representing a single frame to the memory 110 having nA columns×B/n lines, the address converter 150 receives a first address (X,Y) and converts it to a second address (X′,Y′). The gray-scale data input through a predetermined data bus DATA_BUS is stored corresponding to the second address (X′,Y′) in the memory 110.

For the aforementioned operation of the driving IC, gray-scale data of n lines of one column of a frame is input to each of the multiplexers of the multiplexer unit. For this, the second address (X′,Y′) maps the gray-scale data of the n lines of one column for representing the frame such that the gray-scale data is stored in n columns of one line of the memory 110.

The control signal generator 300 generates a control signal ctrl_mux[n:1] for controlling the multiplexer unit 120. The control signal ctrl_mux[n:1] is input to the plurality of multiplexers included in the multiplexer unit 120. The multiplexer unit 120 receives the gray-scale data of nA columns, which has been read from the memory 110, and, response to the control signal ctrl_mux[n:1], sequentially outputs the gray-scale data of A columns for representing the gray-scale of one line of the panel 200.

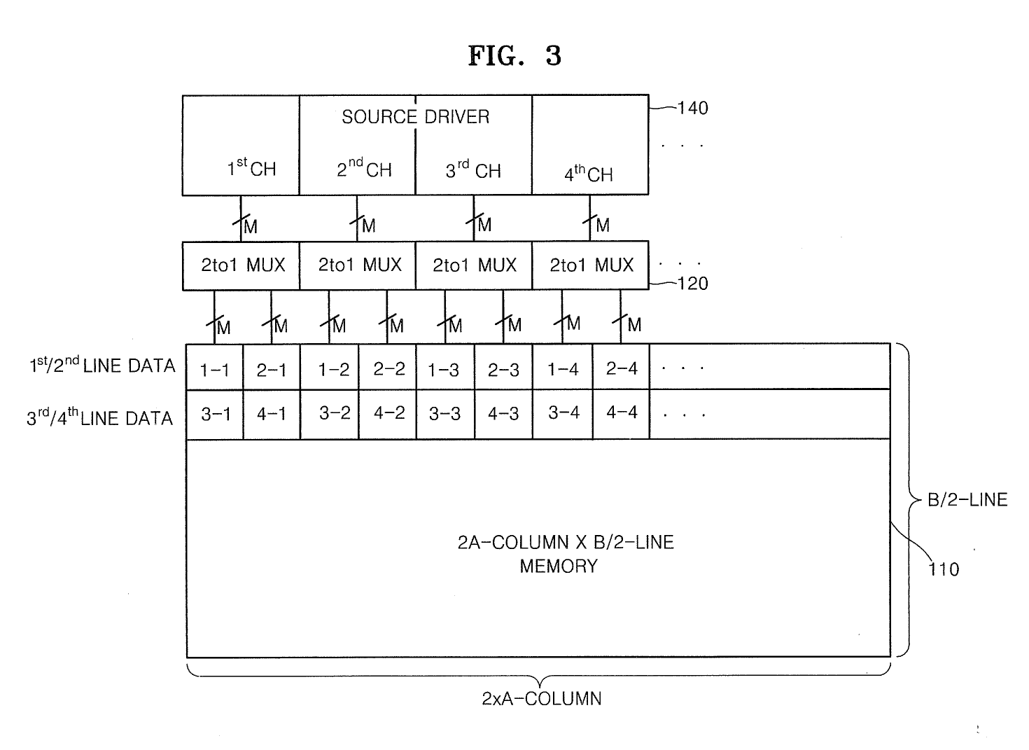

The detailed operation of the driving IC will now be explained with reference to FIG. 3. FIG. 3 is a block diagram of a section of the driving IC of FIG. 2 for illustrating the operation of the driving IC of FIG. 2. FIG. 3 illustrates the memory 110, the multiplexer unit 120 and the source driver 140. For purposes of this illustration, the latch unit 130 has been omitted. The memory 110 includes memory cells corresponding to nA columns×B/n lines to store the gray-scale data corresponding to A columns×B lines for representing a single frame. For example, the memory 110 includes memory cells corresponding to 2A columns×B/2 lines, where “n” equals two. That is, the memory 110 stores gray-scale data of 2A columns of the panel in one row of memory.

Gray-scale data of A columns of the first line of a frame and gray-scale data of A columns of the second line of the frame are stored in the first line of the memory 110. As illustrated in FIG. 3, gray-scale data 1-1, which is among the gray-scale data stored in the first line of the memory 1 10, corresponds to gray-scale data of the first line of the first column of the frame, and gray-scale data 2-1 corresponds to gray-scale data of the second line of the first column of the frame. Gray-scale data 1-2 corresponds to gray-scale data of the first line of the second column of the frame and gray-scale data 2-2 corresponds to gray-scale data of the second line of the second column of the frame. Furthermore, gray-scale data 3-1 corresponds to gray-scale data of the third line of the first column of the frame and gray-scale data 4-1 corresponds to gray-scale data of the fourth line of the first column of the frame. In this manner, gray-scale data corresponding to two lines of the frame, that is, the gray-scale data of 2A columns, is stored in one line of the memory 110.

The gray-scale data of 2A columns, read from one line of the memory 110, is input to the multiplexer unit 120 in parallel. The multiplexer unit 120 can include A 2-to-1 multiplexers. Each multiplexer may be a single-bit or multi-bit multiplexer.

Each of the multiplexers included in the multiplexer unit receives gray-scale data from two columns and sequentially outputs the gray-scale data column by column. For example, the first multiplexer receives the gray-scale data 1-1 and then gray-scale data 2-1 and sequentially outputs the gray-scale data 1-1 and the gray-scale data 1-2. The second multiplexer receives the gray-scale data 1-2 and then the gray-scale data 2-2 and sequentially outputs the gray-scale data 1-2 and the gray-scale data 2-2. In this manner, the multiplexer unit 120 outputs the gray-scale data 1-1 through 1-A corresponding to the first line of the frame among the gray-scale data of 2A columns input to the multiplexer unit 120 in parallel and then outputs the gray-scale data 2-1 through 2-A corresponding to the second line of the frame.

Subsequently, the gray-scale data of 3-1 through 3-A and 4-1 through 4-A of the 2A columns, read from the second line of the memory 110, is input to the multiplexer unit 120 in parallel. The multiplexer unit 120 outputs the gray-scale data 3-1 through 3-A corresponding to the third line of the frame and then outputs the gray-scale data 4-1 through 4-A corresponding to the fourth line of the frame. In this manner, the multiplexer unit 120 outputs gray-scale data corresponding to B lines of the frame to the source driver 140. The output terminals of the multiplexers included in the multiplexer unit 120 are respectively connected to the channels of the source driver 140. The source driver 140 receives the gray-scale data of A columns through A channels, processes the received gray-scale data and transmits the processed gray-scale data to the panel 200.

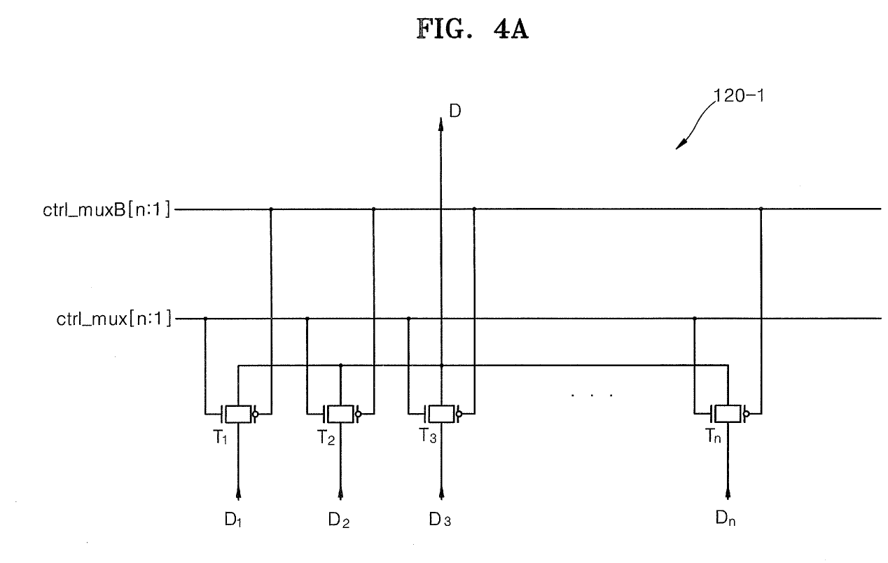

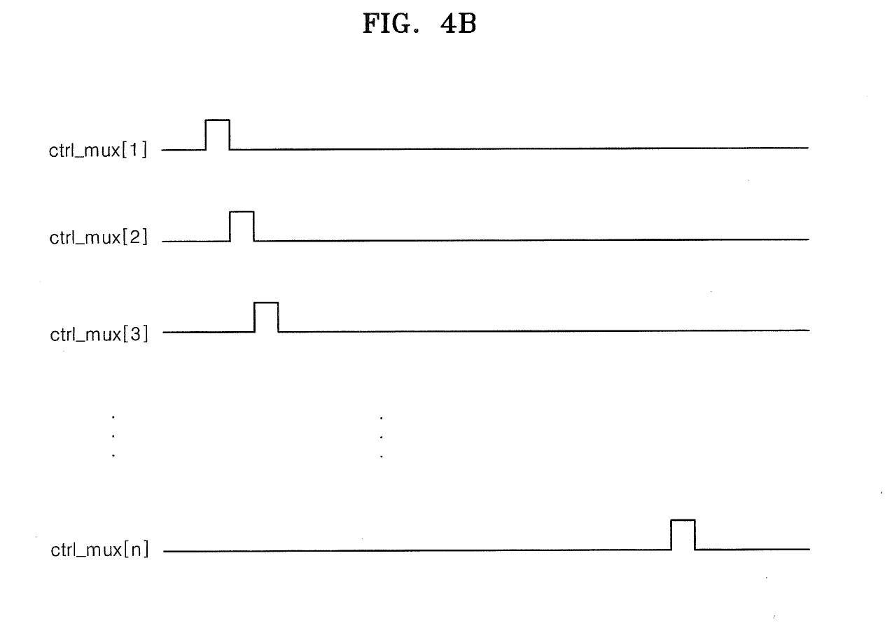

FIG. 4a is a circuit diagram of one cell 120-1 the multiplexer unit 120 of FIG. 2 according to an embodiment of the present invention. FIG. 4a illustrates a multiplexer cell 120-1 that receives gray-scale data of n columns and sequentially outputs gray-scale data column by column for each N column grouping. Referring to FIG. 4a, the multiplexer cell 120-1 receives gray-scale data D1 through Dn of n columns in parallel. As described above, the gray-scale data of n columns from the memory 110 maps to gray-scale data corresponding to n lines of one column of the frame. The gray-scale data D1 through Dn of n columns is sequentially output through an output terminal D column by column.

The multiplexer cell 120-1 can include n transfer gates T1 through Tn to which the gray-scale data D1 through Dn of n columns are respectively input. The transfer gates T1 through Tn can be controlled by a predetermined control signal ctrl_mux[n:1] and an inverted control signal ctrl_muxB[n:1]. The control signal ctrl_mux[n:1] can be generated by the control signal generator 300 of FIG. 2 and the inverted control signal ctrl_muxB [n:1] can be obtained by inverting the control signal ctrl_mux[n:1]. The control signal ctrl_mux[n:1] includes n signals ctrl_mux[1] through ctrl_mux[n] that are respectively input to the transfer gates T1 through Tn through different control signal lines.

FIG. 4b is a waveform diagram of control signals for controlling the multiplexer of FIG. 4a. Referring to FIG. 4b, the control signals ctrl_mux[1] through ctrl_mux[n] are sequentially enabled. When the control signal ctrl_mux[1] is enabled, the gray-scale data D1 of the first line of one column of the frame is output. When the control signal ctrl_mux[2] is enabled, the gray-scale data D2 of the second line for the same column of the frame is output. When the control signal ctrl_mux[n] is enabled, the gray-scale data Dn of the nth line is output. In this manner, the multiplexer cell 120-1 receives the gray-scale data of nA columns in parallel and sequentially outputs the gray-scale data by A column for representing the gray-scale of one line of the panel 200.

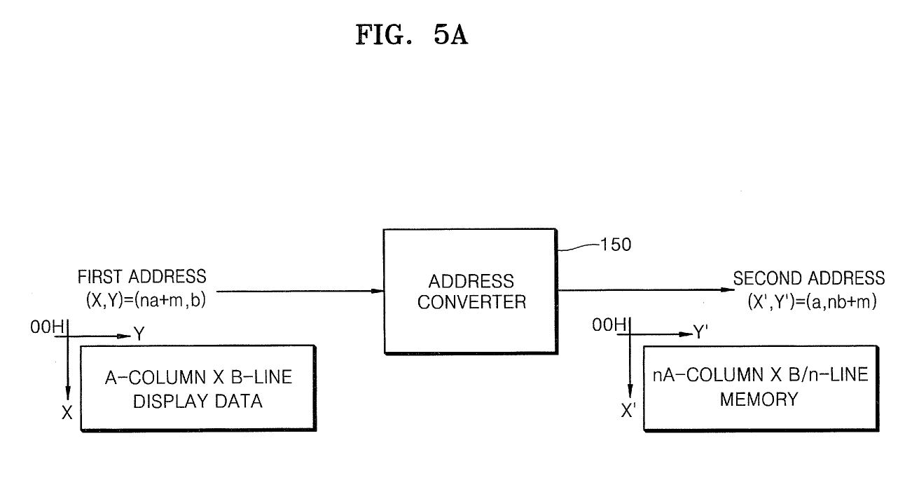

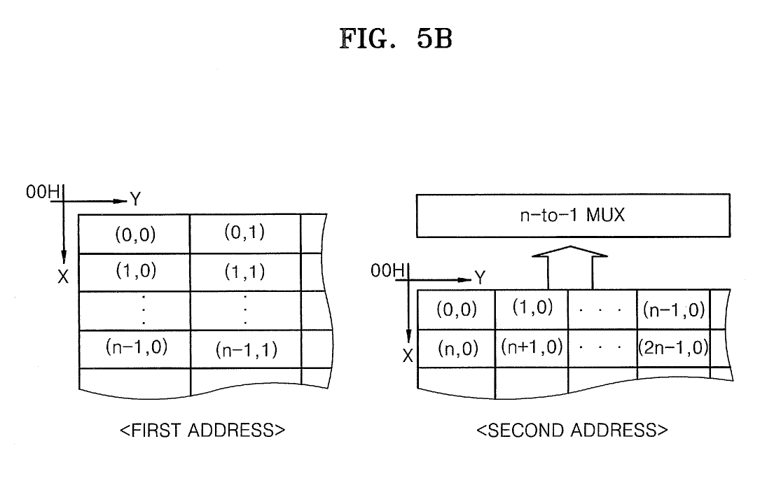

FIGS. 5a and 5b are diagrams for illustrating the operation of the address converter 150 of FIG. 2. Referring to FIG. 5a, the first address (X,Y)=(na+m, b) stores gray-scale data in a position corresponding to the first address in the memory when the gray-scale data is stored in the memory having A columns×B lines. The address converter 150 receives the first address (X,Y) and converts the first address data (X,Y) to the second address (X′,Y′)=(a, nb+m). The second address data (X′,Y′) stores gray-scale data in a position corresponding to the second address in the memory when the gray-scale data is stored in the memory having nA columns×B/n lines. Here, a and b are integers and m is a non-negative integer smaller than n.

Referring to FIG. 5b, when the first address (X,Y) is (1,0), the first address (X,Y) stores gray-scale data in the first column of the second line of the memory having A columns×B lines. Since the first address (1,0) is (n×0+1, 0), the second address (X′,Y′) generated by the address converter 150 becomes (0,1). Accordingly, the second address (X′,Y′) stores the gray-scale data in the second column of the first line of the memory having nA columns×B/n lines. When the first address (X,Y) is (n−1, 0), the first address (X,Y) stores the gray-scale data in the first column of the nth line of the memory having A column×B lines. Since the first address (n−1, 0) corresponds to (n×0+n−1, 0), the second address (X′,T′) generated by the address converter 150 becomes (0, n−1). Accordingly, the second address (X′,Y′) stores the gray-scale data in the nth column of the first line of the memory having nA columns×B/n lines.

Based on this conversion method, a 2×15 sub-array of graphics data within an integrated circuit memory 110 (i.e., a sub-array having two rows and fifteen columns) will map to a 10×3 sub-array of pixels (i.e., a sub-array having ten rows and three columns) within a display, according to the following tables (for the case where “n” equals 5):

TABLE 1
MEMORY DATA (rows 0–1, columns 0–14)

| | | | | | | | | | | | | | | |
|---|---|---|---|---|---|---|---|---|---|---|---|---|---|---|
| 0, 0 | 1, 0 | 2, 0 | 3, 0 | 4, 0 | 0, 1 | 1, 1 | 2, 1 | 3, 1 | 4, 1 | 0, 2 | 1, 2 | 2, 2 | 3, 2 | 4, 2 |
| 5, 0 | 6, 0 | 7, 0 | 8, 0 | 9, 0 | 5, 1 | 6, 1 | 7, 1 | 8, 1 | 9, 1 | 5, 2 | 6, 2 | 7, 2 | 8, 2 | 9, 2 |

TABLE 2
LCD PIXEL DATA
(row, column)

| | | |
|---|---|---|
| 0, 0 | 0, 1 | 0, 2 |
| 1, 0 | 1, 1 | 1, 2 |
| 2, 0 | 2, 1 | 2, 2 |
| 3, 0 | 3, 1 | 3, 2 |
| 4, 0 | 4, 1 | 4, 2 |
| 5, 0 | 5, 1 | 5, 2 |
| 6, 0 | 6, 1 | 6, 2 |
| 7, 0 | 7, 1 | 7, 2 |
| 8, 0 | 8, 1 | 8, 2 |
| 9, 0 | 9, 1 | 9, 2 |

According to the above-described address data conversion method, the gray-scale data of n lines of one column for representing a single frame is stored in n columns of one line of the memory.

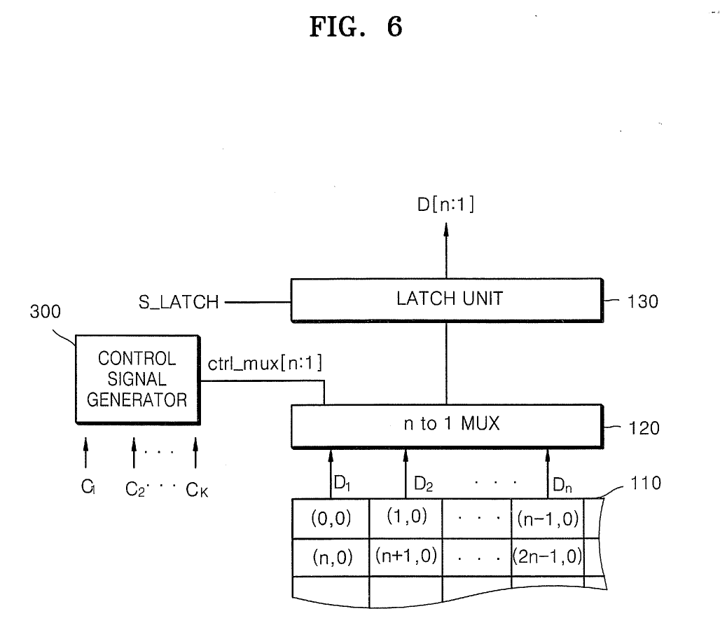

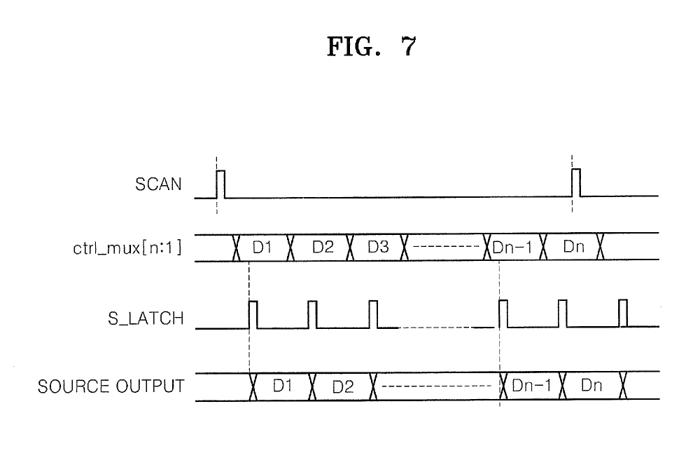

FIG. 6 is a block diagram of the driving IC of FIG. 2 for illustrating a general operation of the driving IC of FIG. 2, and FIG. 7 is a waveform diagram of control signals for controlling the driving IC of FIG. 6. As illustrated in FIG. 6, gray-scale data corresponding to n lines of one column for representing a single frame is stored in n columns of one line of the memory 110. When a memory scan signal illustrated in FIG. 7 is enabled, one line of the memory 110 is scanned and thus gray-scale data D1 through Dn stored in the n columns is read. The gray-scale data D1 through Dn corresponds to the gray-scale data of n lines of one column of the frame.

The read gray-scale data D1 through Dn is input to an n-to-1 multiplexer 120 in parallel. The n-to-1 multiplexer 120 receives the control signal ctrl_mux[n:1] from the control signal generator 300 and controls the output of the gray-scale data D1 through Dn. That is, the n-to-1 multiplexer 120 sequentially outputs the gray-scale data D1 through Dn of the n lines of one column of the frame in response to the control signal ctrl_mux[n:1].

The gray-scale data D1 through Dn sequentially output from the n-to-1 multiplexer 120 is latched by the latch unit 130. A latch control signal S_LATCH illustrated in FIG. 7 controls the latch unit 130 to latch the gray-scale data D1 through Dn sequentially output from the n-to-1 multiplexer 120. The latched gray-scale data D[n:1] is converted into an analog signal by the source driver and output to the panel.

To correctly transmit the gray-scale data, the control signal generator 300 receives K predetermined input signals C1 through CK and generates the control signal ctrl_mux[n:1] in synchronization with the input signals C1 through CK. For example, when the multiplexer 120 is a 9-to1 multiplexer, the control signal ctrl_mux[n:1] includes 9 signals. In this case, four input signals (i.e., a 4-bit binary signal) are needed because 2³<9 and 2⁴>9.

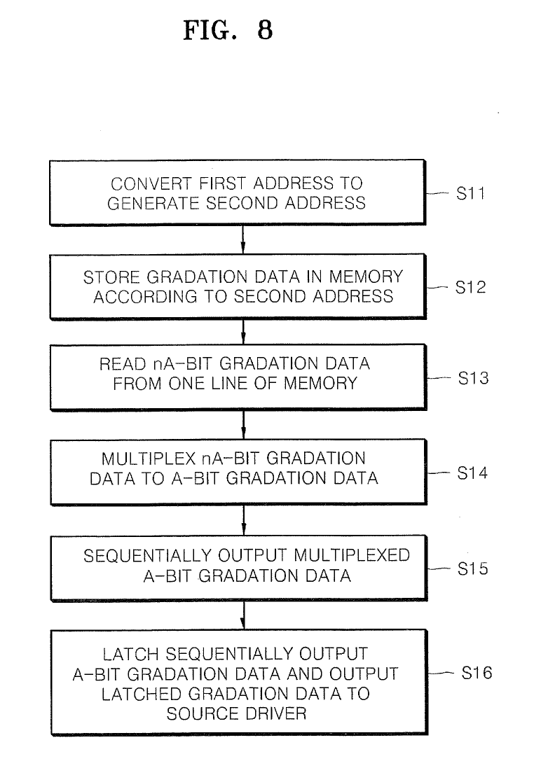

FIG. 8 is a flow chart illustrating a display driving method according to an embodiment of the present invention. Referring to FIG. 8, a first address for mapping gray-scale data of a frame to a memory is converted to second address in step S11. The first address maps the gray-scale data to a memory having A columns×B lines and the second address maps the gray-scale data to a memory having nA columns×B/n lines. The gray-scale data is stored in the memory according to the second address in step S12. Specifically, gray-scale data corresponding to n lines of one column for representing a frame is stored in n columns of one line of the memory according to a mapping characteristic of the second address. The memory is scanned such that gray-scale data of nA columns is read from one line of the memory in step S13. The read gray-scale data is input to a predetermined multiplexer in parallel. The gray-scale data of nA columns corresponds to gray-scale data of n lines of the frame.

The multiplexer multiplexes the gray-scale data of nA columns in step S14 and sequentially outputs the gray-scale data by A frames for representing the gray-scale of one line of the frame in step S15. That is, the multiplexer outputs the gray-scale data of A columns for representing the gray-scale of one line of the frame among the gray-scale data of nA columns, and then outputs the gray-scale data of A columns for representing the gray-scale of another line of the frame to represent an image corresponding to the gray-scale data of nA columns read from the memory.

Then, the gray-scale data sequentially output by A frames is latched and output to a source driver in step S16. The source driver processes the gray-scale data, converts the gray-scale data into analog signals and transmits the analog signals to a panel. The panel displays an image corresponding to the analog signals.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A visual display driver, comprising:
a memory array having a plurality of rows and columns of memory cells therein; and
a multiplexer unit comprising a plurality of N-to-1 multiplexers configured to route display data from N×M columns in said memory array to an M-bit wide data bus, in response to a multiplexer control signal, where N and M are positive integers greater than one.

2. The display driver of claim 1, further comprising an M-channel source driver electrically coupled to the M-bit wide data bus.

3. The display driver of claim 1, further comprising:
an M-bit latch unit electrically coupled to an output of said multiplexer unit; and
a channel source driver electrically coupled to an output of said M-bit latch unit.

4. The display driver of claim 1, further comprising:
an address converter configured to convert multiple distinct line addresses applied thereto into a corresponding plurality of distinct memory addresses that map to a single row within said memory array.

5. The display driver of claim 4, wherein the plurality of distinct memory addresses map to different groups of columns within the single row.

6. A visual display driver, comprising:
a memory array having a plurality of rows and columns of memory cells therein; and
an address converter configured to convert multiple distinct addresses applied thereto into a corresponding plurality of distinct memory addresses that map to a single row of memory cells in said memory array.

7. The display driver of claim 6, wherein said address converter is configured to convert N consecutively valued addresses applied thereto into a corresponding plurality of distinct memory addresses that map to a single row in said memory array, where N is a positive integer greater than one.

8. The display driver of claim 7, further comprising a multiplexer unit comprising a plurality of N-to-1 multiplexers configured to route display data from N×M columns in said memory array to an M-bit wide display data bus, in response to a multiplexer control signal, where M is a positive integer greater than one.

9. A method of operating a graphics display, comprising the steps of:
reading a row of display data from a graphics memory array;
extracting multiple lines of frame data from the row of display data; and
sequentially scanning the multiple lines of frame data onto multiple lines of pixels in the display.

10. The method of claim 9, wherein said extracting step comprises passing N lines of frame data in sequence through an N-to-1 multiplexer unit, wherein N is a positive integer greater than one.

11.-32. (canceled)
